(19) United States
(12) Patent Application Publication
(10) Pub. No.: US 2026/0183190 A1
(43) Pub. Date: Jul. 2, 2026

(54) ABDOMINAL MASSAGE DEVICE EQUIPPED WITH SONIC VIBRATION MODULE

(71) Applicant: Ceragem Co., Ltd., Cheonan-si, Chungcheongnam-do (KR)

(72) Inventors: Sang Ho Choi, Cheonan-si, Chungcheongnam-do (KR); Sang Woo Park, Cheonan-si, Chungcheongnam-do (KR); Sung Jae Hwang, Pyeongtaek-si, Gyeonggi-do (KR); Ki Sung Kim, Cheonan-si, Chungcheongnam-do (KR); Dong Myoung LEE, Asan-si, Chungcheongnam-do (KR)

(21) Appl. No.: 19/128,094

(22) PCT Filed: Oct. 6, 2023
(86) PCT No.: PCT/KR2023/015416

§ 371 Date: May 7, 2025

(30) Foreign Application Priority Data
Nov. 8, 2022 (KR) 10-2022-0147574

(51) Int. Cl. A61H 39/00; A61H 15/00; A61H 23/02; A61H 39/04

(52) U.S. Cl. CPC A61H 39/007; A61H 15/0078; A61H 23/0236; A61H 39/04; A61H 2201/0107; A61H 2201/0169; A61H 2205/083

(57) ABSTRACT

An abdominal massage device equipped with a sonic vibration module, according to an aspect of the present invention, may comprise: a lower cover part which is arranged to be brought into contact with a user's abdomen; an acupressure part which is supported by the lower covert part; a vibration generation part which is arranged in contact with the acupressure part and is provided with a sonic vibration module for generating sonic vibrations; and an upper cover part which is arranged opposite to the lower cover part to cover the top portion of the vibration generation part, wherein the sonic vibration module includes: a magnet which is elastically supported by a first elastic member; and a coil which is arranged to surround the magnet so that the magnet is vibrated when a current is applied to the coil.

### TECHNICAL FIELD

The present invention relates to a massage device, and more particularly, to an abdominal massage device.

### BACKGROUND

In general, with the rapid growth of industrial society, various digestive disorders including visceral diseases and abdominal obesity are on the rise due to factors such as lack of physical activity, excessive workload, and irregular eating habits, which hinder the proper functioning of the body's metabolism.

In addition, due to the nature of people who work while sitting for long periods, physical activity tends to decrease, and the lack of proper exercise during leisure time has led to an increase in abdominal obesity. Although some have attempted to address this by exercising at fitness centers, it has become difficult to use such facilities due to situational factors such as the COVID-19 pandemic. While some individuals have equipped their homes with personal exercise equipment to exercise at home, the effectiveness has often fallen short of expectations.

Various abdominal massage devices have been proposed to address problems such as the deterioration of internal organ functions caused by abdominal obesity. For example, Korean Patent Laid-Open Publication No. 10-2017-0052453 discloses a conventional abdominal massage device. The conventional abdominal massage device is configured such that a spherical massage part rotates to massage the user's abdomen. However, such a configuration results in a large volume, making storage difficult and reducing the effectiveness of the abdominal massage.

Therefore, there is a need for improvement in this regard.

(Patent Document 1) Korean Patent Laid-Open Publication No. 10-2017-0052453

### DISCLOSURE

### Technical Problem

The present invention is to solve the above problems, and the present invention is directed to providing an abdominal massage device capable of massaging a user's abdomen using sonic vibrations.

The present invention is also directed to providing an abdominal massage device in which the sonic vibrations are transmitted solely to the user's abdomen, while minimizing the transmission of such vibrations to other parts of the device held by the user.

The problems of the present invention are not limited to those mentioned above, and other problems not mentioned will be clearly understood by those of ordinary skill in the art from the following description.

### Technical Solution

According to an aspect of the present invention, provided is an abdominal massage device equipped with a sonic vibration module, comprising: a lower cover part arranged to be brought into contact with a user's abdomen; an acupressure part supported by the lower cover part; a vibration generation part arranged in contact with the acupressure part and provided with a sonic vibration module for generating sonic vibrations; and an upper cover part disposed opposite to the lower cover part to cover an upper portion of the vibration generation part, wherein the sonic vibration module comprises a magnet elastically supported by a first elastic member, and a coil arranged to surround the magnet such that the magnet vibrates when a current is applied to the coil.

In this case, the sonic vibration module may further include a housing arranged to surround the magnet, the first elastic member, and the coil, the housing being provided with a vibration plate to which vibration of the magnet is transmitted, and the vibration generation part may further include a second elastic member that elastically supports the housing.

In this case, the second elastic member may include a body that surrounds a perimeter of the housing, and a leg that extends along a circumferential direction of the body and is formed with a slit so as to be spaced apart from the body by a predetermined distance.

In this case, the abdominal massage device may further include a plate part fixedly disposed in the upper cover part and provided with a fixing bar to which the leg is fixed, and the plate part may be provided with a transmission prevention hole configured to prevent the sonic vibration module from coming into contact with the plate part.

In this case, the transmission prevention hole may be disposed at a position overlapping the sonic vibration module in a height direction.

In this case, the plate part may be provided with a fixing member that is inserted and fixed into a fastening hole formed in the fixing bar while passing through a through hole formed in the leg, and a blocking member configured to prevent the transmission of sonic vibrations may be provided on an inner circumferential surface of the through hole.

In this case, the acupressure part may include an acupressure ball arranged to be in contact with a user's abdomen, and a fixing foam configured to fix a position of the acupressure ball.

In this case, a damping member configured to prevent noise caused by impact may be provided between the sonic vibration module and the acupressure part.

In this case, a guide rib extending in a height direction may be provided on an inner circumferential surface of the transmission prevention hole, the damping member may be disposed inside the guide rib, and the damping member and the guide rib may be spaced apart from each other in a width direction.

In this case, a heating member for heating the acupressure part may be provided between the plate part and the acupressure part.

In this case, a separation space may be provided between the sonic vibration module and the upper cover part.

In this case, a vibration-isolating foam member configured to prevent resonance between the upper cover part and the sonic vibration module may be provided in the separation space.

In this case, the lower cover part may be disposed along a perimeter of the acupressure part so that the acupressure part is exposed toward the user's abdomen.

### Advantageous Effect

According to the above configuration, the abdominal massage device equipped with a sonic vibration module according to an embodiment of the present invention massages the user's abdomen using sonic vibrations generated by the sonic vibration module, thereby minimizing the overall volume for easy storage and enabling effective abdominal massage through the sonic vibrations.

In addition, the abdominal massage device equipped with a sonic vibration module according to an embodiment of the present invention allows the sonic vibrations to be transmitted only to the acupressure part that presses the user's abdomen, while minimizing the transmission of sonic vibrations to the upper cover part, which the user grips by hand to hold the device in place. As a result, the device maximizes the abdominal massage effect while ensuring comfortable use for the user.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view illustrating an assembled state of an abdominal massage device according to an exemplary embodiment of the present invention.

FIG. 2 is a perspective view illustrating a disassembled state of an abdominal massage device according to an exemplary embodiment of the present invention.

FIG. 3 is a cross-sectional view taken along line I-I of FIG. 1.

FIG. 4 is a perspective view illustrating an assembled state of a sonic vibration module of the abdominal massage device according to an exemplary embodiment of the present invention.

FIG. 5 is a cross-sectional view of a sonic vibration module of the abdominal massage device according to an exemplary embodiment of the present invention.

FIG. 6 is an enlarged view of portion A of FIG. 3.

FIG. 7 is a cross-sectional view of an abdominal massage device according to another embodiment of the present invention.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

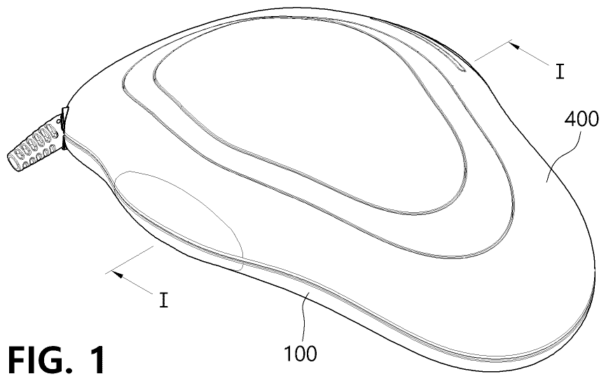

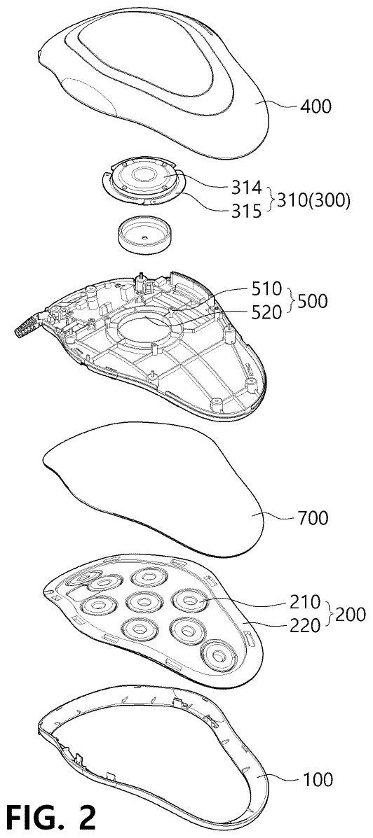

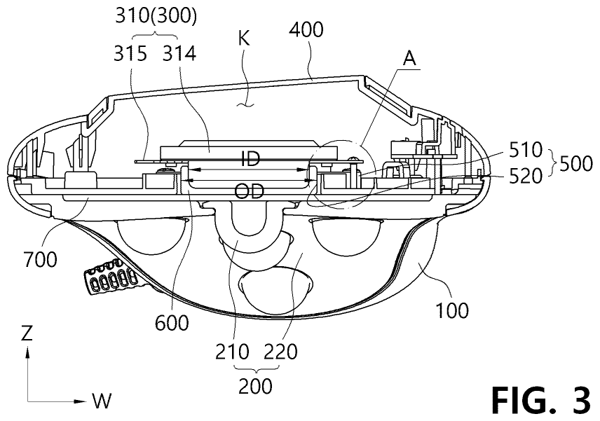

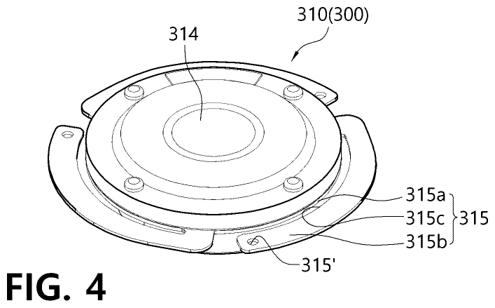

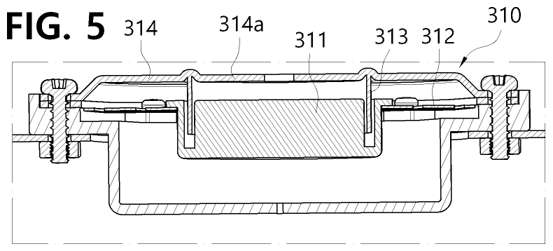

FIG. 1 is a perspective view illustrating an assembled state of an abdominal massage device according to an exemplary embodiment of the present invention, FIG. 2 is a perspective view illustrating a disassembled state of an abdominal massage device according to an exemplary embodiment of the present invention, FIG. 3 is a cross-sectional view taken along line I-I of FIG. 1, FIG. 4 is a perspective view illustrating an assembled state of a sonic vibration module of the abdominal massage device according to an exemplary embodiment of the present invention, and FIG. 5 is a cross-sectional view of a sonic vibration module of the abdominal massage device according to an exemplary embodiment of the present invention. Here, the Z direction indicates the height direction of the abdominal massage device, and the W direction indicates the width direction of the abdominal massage device.

As shown in FIGS. 1 to 3, an abdominal massage device equipped with a sonic vibration module according to an embodiment of the present invention includes a lower cover part 100 arranged to be brought into contact with a user's abdomen, an acupressure part 200 supported by the lower cover part 100, a vibration generation part 300 which is arranged in contact with the acupressure part 200 and is provided with a sonic vibration module 310 for generating sonic vibrations, and an upper cover part 400 disposed opposite to the lower cover part 100 to cover an upper portion of the vibration generation part 300.

The lower cover part 100 may be provided with an open region at its center so that the acupressure part 200 is exposed to the outside. For example, the lower cover part 100 may be disposed around a perimeter of the acupressure part 200. The lower cover part 100 may be provided with locking protrusions at a plurality of positions along its perimeter. Such locking protrusions may be fitted into locking holes formed in the acupressure part 200.

The coupling structure between the lower cover part 100 and the acupressure part 200 is not limited thereto and may be implemented in various forms. For example, the lower cover part 100 and the acupressure part 200 may be coupled by bolting, welding, bonding, or press-fitting.

A stepped surface may be provided along the perimeter of the acupressure part 200. A portion of the lower cover part where the locking protrusion is provided may be seated on the stepped surface. Here, the stepped surface may be formed with a smaller thickness than the center portion of the acupressure part 200. The above-described locking holes may be provided on the stepped surface.

As described above, the upper cover part 400 is disposed opposite to the upper side of the lower cover part 100, and a space in which the acupressure part 200 and the sonic vibration module 310 are arranged may be provided between the upper cover part 400 and the lower cover part 100. Here, the upper cover part 400 may be coupled to the lower cover part 100 by a fitting method.

Since the abdominal massage device operates for a certain period of time while being seated on the user's abdomen, it is preferable that the upper cover part 400 is configured to be gripped by the user's hand. The abdominal massage device may be provided with a handle hole that the user can grip by hand or a belt that can be fastened around the user's waist.

In this case, as shown in FIGS. 4 and 5, the sonic vibration module 310 includes a magnet 311 elastically supported by a first elastic member 312, and a coil 313 arranged to surround a perimeter of the magnet 311 such that the magnet 311 vibrates when a current is applied to the coil.

The first elastic member 312 elastically supports the magnet 311 while being fixed inside a housing 314, which will be described later. A coil bobbin having a coil groove may be provided to wind the coil 313, and for this purpose, the housing 314 may be formed with a space in which the coil bobbin can be arranged.

When a current is applied to the coil 313, the magnet 311 vibrates due to a force generated by the magnetic field formed in the magnet 311. The magnet 311 vibrates according to the frequency (sonic wave) selected by the user, thereby outputting sonic vibrations, which are transmitted to the acupressure part 200 to perform an abdominal massage.

That is, the abdominal massage device equipped with a sonic vibration module according to an embodiment of the present invention massages the user's abdomen using sonic vibrations generated by the sonic vibration module 310, thereby minimizing the overall volume for easy storage and enabling effective abdominal massage through the sonic vibrations.

As shown in FIGS. 3 to 5, the sonic vibration module 310 further includes a housing 314 that is arranged to surround the magnet 311, the first elastic member 312, and the coil 313, and is provided with a vibration plate 314a to which the vibration of the magnet 311 is transmitted. The vibration generation part 300 may further include a second elastic member 315 that elastically supports the housing 314.

That is, as described above, when a current is applied to the coil 313, the magnet 311 vibrates to output sonic vibrations, and these sonic vibrations are transmitted to the outside through the vibration plate 314a provided in the housing 314. The sonic vibrations output to the outside are delivered to the user through the acupressure part 200.

In addition, since the housing 314 is elastically supported by the second elastic member 315, the housing 314 is configured to vibrate together as the sonic vibrations are output to the outside through the vibration plate 314a, thereby increasing the output of the sonic vibrations and maximizing the effect of the abdominal massage.

If the first elastic member 312 and the second elastic member 315 are configured to have matching vibration frequencies, the abdominal massage effect can be further enhanced through a resonance phenomenon.

As shown in FIG. 4, the second elastic member 315 may include a body 315a that surrounds a perimeter of the housing 314, and a leg 315b that extends along a circumferential direction of the body 315a and is formed with a slit 315c to be spaced apart from the body 315a by a predetermined distance.

The second elastic member 315 may be formed of an elastic material and may be fixed to a plate part 500 that is fixedly disposed in the upper cover part 400, as will be described later. The body 315a may be provided with a coupling hole through which a coupling protrusion provided on the housing 314 is inserted and fixed. That is, the coupling protrusion of the housing 314 is configured to be secured to the coupling hole by being inserted therethrough during the coupling process.

The body 315a, to which the housing 314 is secured, is extended with the leg 315b, and through this leg 315b, the second elastic member 315 is fixed to the plate part 500. The second elastic member 315 may be formed with a slit 315c so that the leg 315b is spaced apart from the body 315a by a predetermined distance. The leg 315b may be formed to extend a predetermined length along the circumferential direction of the body 315a, and with the formation of the slit 315c, the leg 315b can be spaced apart from the body 315a, thereby preventing the sonic vibrations from being transmitted to the plate part 500.

As shown in FIG. 3, the abdominal massage device may further include a plate part 500 fixedly disposed in the upper cover part 400, the plate part 500 being provided with a fixing bar 510 to which the leg 315b is fixed, and the plate part 500 may be provided with a transmission prevention hole 520 to prevent the sonic vibration module 310 from coming into contact with the plate part 500.

That is, the sonic vibration module 310 is fixed to the fixing bar 510 of the plate part 500 through the second elastic member 315, and with the provision of the transmission prevention hole 520, the sonic vibrations generated by the sonic vibration module 310 are prevented from being transmitted to the plate part 500, while being configured to be directly transmitted to the acupressure part 200.

According to the above configuration, the abdominal massage device equipped with a sonic vibration module according to an embodiment of the present invention allows the sonic vibrations to be transmitted only to the acupressure part 200 that presses the user's abdomen, while minimizing the transmission of sonic vibrations to the upper cover part 400, which the user grips by hand to hold the device in place. As a result, the device maximizes the abdominal massage effect while ensuring comfortable use for the user.

In this case, as shown in FIG. 3, the transmission prevention hole 520 may be disposed at a position overlapping the sonic vibration module 310 in the height direction (Z), and the inner diameter (ID) of the transmission prevention hole 520 may be greater than the outer diameter (OD) of the sonic vibration module 310.

Through this configuration, sonic vibrations generated by the sonic vibration module 310 and emitted to the outside can be more effectively prevented from being transmitted to the plate part 500, thereby enhancing user convenience.

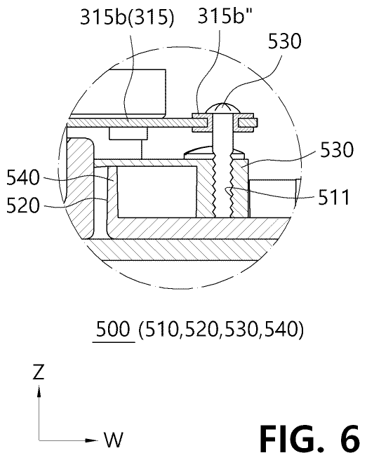

FIG. 6 is an enlarged view of portion A of FIG. 3.

As shown in FIG. 6, the plate part 500 may be provided with a fixing member 530 that is inserted and fixed into a fastening hole 511 formed in the fixing bar 510 while passing through a through hole 315b′ formed in the leg 315b, and a blocking member 315b″ for preventing the transmission of sonic vibrations may be provided on the inner circumferential surface of the through hole 315b′.

The blocking member 315b″ is disposed between the second elastic member 315 and the fixing bar 510 to prevent the sonic vibrations transmitted through the second elastic member 315 from being further transmitted to the plate part 500 via the fixing bar 510.

The blocking member 315b″ may be configured as a separate component that is inserted and arranged during the process of assembling the second elastic member 315 to the fixing bar 510 of the plate part 500. However, as shown in FIG. 6, it is also possible to configure the blocking member 315b″ to be integrally formed with the second elastic member 315. That is, the blocking member 315b″ is configured to be inserted into the through hole 315b′ formed in the leg 315b of the second elastic member 315 and to extend radially outward along the upper and lower surfaces of the leg 315b to surround a predetermined portion around the through hole 315b′. For example, the blocking member 315b″ may be integrally formed with the second elastic member 315 using an insert injection molding method.

The acupressure part 200 may include an acupressure ball 210 that is arranged to be in contact with the user's abdomen, and a fixing foam 220 that fixes the position of the acupressure ball 210. The fixing foam 220 may be a skin foam made of an elastic material, and when the fixing foam 220 is formed of an elastic material, it can reduce noise caused by the output of sonic vibrations. In addition, since the fixing foam 220 comes into direct contact with the user's abdomen, forming it as a skin foam can provide a soft touch to the user. Moreover, as the portion exposed to the outside is made of skin foam, it can offer a luxurious appearance similar to leather, thereby enhancing user satisfaction.

The fixing foam 220 may be formed with a plurality of insertion holes in which the acupressure balls 210 are inserted. The plurality of insertion holes may be formed at positions corresponding to acupressure points on the abdomen. The insertion holes may be formed in the fixing foam 220 either regularly or irregularly.

The acupressure ball 210 may be made of a material that can provide various functionalities such as far-infrared radiation, enhancement of immunity, or shielding of electromagnetic waves. In addition, the acupressure ball 210 may be made of a material with excellent thermal conductivity so as to effectively transfer heat from a heating member 700, which will be described later, to the user's abdomen.

Here, although the shape of the acupressure ball 210 is not particularly limited, it is preferable that the lower portion of the acupressure ball 210 be spherical so that the sonic vibrations emitted from the sonic vibration module 310 are evenly transmitted to the user's abdomen.

In this case, the acupressure ball 210 may be formed to have a certain height so as to protrude outward from the fixing foam 220. Here, the certain height may be an appropriate height for applying acupressure to the user's abdomen. That is, the acupressure ball 210 may have a cylindrical shape with a certain height, and its lower end portion may be formed in a dome shape to be convex.

Accordingly, when the acupressure ball 210 comes into contact with the user's abdomen, the sonic vibrations generated by the sonic vibration module 310 can be transmitted more effectively.

A plurality of acupressure balls 210 may be provided and respectively inserted into the plurality of insertion holes of the fixing foam 220.

A fixing rib extending outward in the radial direction may be provided around the periphery of the acupressure ball 210. The fixing rib may be seated in a seating groove formed along the periphery of the insertion hole. Here, the inner diameter of the insertion hole may be formed to be equal to the outer diameter of the acupressure ball 210. Through this configuration, the acupressure ball 210 may be inserted into the insertion hole by an interference fit.

In addition, since the fixing rib of the acupressure ball 210 is secured by the seating groove of the fixing foam 220, the acupressure ball 210 can operate stably without detaching from the fixing foam 220 even when sonic vibrations are emitted.

A hollow region open upward may be formed inside the acupressure ball 210. That is, the acupressure ball 210 may be provided with a dome-shaped wall having a certain thickness and a hollow interior. Accordingly, when heat is transferred from the heating member 700, the heat can be quickly conducted along the dome-shaped wall, thereby improving the thermal efficiency of the acupressure ball 210. In addition, the acupressure ball 210 can reduce manufacturing costs by preventing unnecessary material waste through the use of a dome-shaped wall.

As described above, since the lower cover part 100, the fixing foam 220, and the acupressure ball 210 are assembled by a fitting method, respectively, the manufacturing process can be simplified, and the time required for curing an adhesive is eliminated, thereby reducing the overall manufacturing time.

As shown in FIG. 3, a damping member 600 for preventing noise caused by impact may be provided between the sonic vibration module 310 and the acupressure part 200. That is, during the process in which sonic vibrations are emitted from the sonic vibration module 310, if the sonic vibration module 310 collides with the acupressure ball 210, impact noise may be generated and the acupressure ball 210 may be damaged, potentially causing injury to the user. However, as described above, when the damping member 600 is provided, it can prevent the collision between the sonic vibration module 310 and the acupressure ball 210, while also allowing the sonic vibrations to be transmitted smoothly.

An inner circumferential surface of the transmission prevention hole 520 may be provided with a guide rib 540 extending in the height direction (Z), and the damping member 600 may be disposed inside the guide rib 540. With the guide rib 540 formed in this manner, it is possible to prevent the damping member 600 from unintentionally disengaging due to sonic vibrations during the abdominal massage process.

In this case, the damping member 600 and the guide rib 540 may be spaced apart from each other in the width direction (W), thereby preventing the sonic vibrations being emitted from being transmitted to the plate part 500 through the damping member 600.

As shown in FIG. 3, a heating member 700 for heating the acupressure part 200 may be provided between the plate part 500 and the acupressure part 200. The heating member 700 may include a heating element and a scaffold that fixedly supports the heating element. That is, the scaffold serves to support the heating element, and its material is not particularly limited.

The heating element may be arranged to be in direct contact with upper surfaces of the plurality of acupressure balls 210. For example, the heating element may be a heating wire integrally formed in an extended manner and may be arranged in a zigzag pattern so as to pass over the upper surfaces of the acupressure balls 210. That is, the heating element may be arranged in a zigzag pattern from one side to the other in the width direction (W) of the acupressure part 200.

The heating element is not limited to a linear shape and may also be formed in a plate shape. The heating element may include an aluminum heating element, a carbon nonwoven fabric, a cotton mesh heating element, or a carbon fiber heating element.

The fixing foam 220 may be formed with a fixing groove for positioning the heating member 700, and the plate part 500 presses and fixes the heating member 700 while the heating member 700 is inserted and positioned in the fixing groove.

With the heating member 700 provided in this manner, both acupressure through sonic vibrations and thermal therapy can be simultaneously delivered, thereby maximizing the abdominal massage effect.

As shown in FIG. 3, a separation space (K) may be provided between the sonic vibration module 310 and the upper cover part 400. With the separation space (K) provided in this manner, the sonic vibration module 310 does not come into direct contact with the upper cover part 400, thereby preventing direct transmission of sonic vibrations.

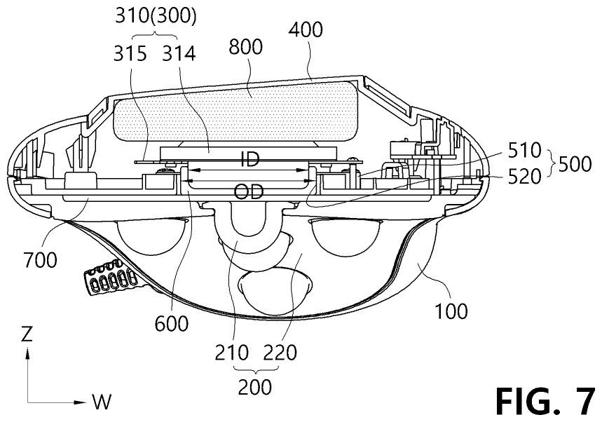

FIG. 7 is a cross-sectional view of an abdominal massage device according to another embodiment of the present invention.

As shown in FIG. 7, a vibration-isolating foam member 800 may be provided in the separation space (K) to prevent resonance between the upper cover part 400 and the sonic vibration module 310. When sonic vibrations are emitted from the sonic vibration module 310, the air inside the separation space (K) may vibrate, potentially causing unintended shaking or noise in the abdominal massage device. However, with the vibration-isolating foam member 800 provided as described above, it is possible to prevent the air inside the separation space (K) from vibrating due to the sonic vibration module 310, thereby preventing the aforementioned shaking or noise issues.

As shown in FIG. 3, the lower cover part 100 may be disposed along a perimeter of the acupressure part 200 so that the acupressure part 200 is exposed toward the user's abdomen. Through this configuration, the acupressure part 200 can be effectively secured, and effective abdominal massage can be achieved through the acupressure part 200 exposed to the outside.

As described above, the abdominal massage device equipped with a sonic vibration module according to an embodiment of the present invention allows the sonic vibrations to be transmitted only to the acupressure part 200 that presses the user's abdomen, while minimizing the transmission of sonic vibrations to the upper cover part 400, which the user grips by hand to hold the device in place. As a result, the device maximizes the abdominal massage effect while ensuring comfortable use for the user.

Although exemplary embodiments of the present invention have been described above, the idea of the present invention is not limited to the embodiments set forth herein. Those of ordinary skill in the art who understand the spirit of the present invention may easily propose other embodiments through supplement, change, removal, addition, etc. of elements within the same spirit, but the embodiments will be also within the scope of the present invention.

1. An abdominal massage device equipped with a sonic vibration module, comprising:
a lower cover part arranged to be brought into contact with a user's abdomen;
an acupressure part supported by the lower cover part;
a vibration generation part arranged in contact with the acupressure part and provided with a sonic vibration module for generating sonic vibrations; and
an upper cover part disposed opposite to the lower cover part to cover an upper portion of the vibration generation part,
wherein the sonic vibration module comprises a magnet elastically supported by a first elastic member, and a coil arranged to surround the magnet such that the magnet vibrates when a current is applied to the coil.

2. The abdominal massage device equipped with a sonic vibration module of claim 1,
wherein the sonic vibration module further comprises a housing arranged to surround the magnet, the first elastic member, and the coil, the housing being provided with a vibration plate to which vibration of the magnet is transmitted, and
the vibration generation part further comprises a second elastic member that elastically supports the housing.

3. The abdominal massage device equipped with a sonic vibration module of claim 2, wherein the second elastic member comprises a body that surrounds a perimeter of the housing, and a leg that extends along a circumferential direction of the body and is formed with a slit so as to be spaced apart from the body by a predetermined distance.

4. The abdominal massage device equipped with a sonic vibration module of claim 3,
further comprising a plate part fixedly disposed in the upper cover part and provided with a fixing bar to which the leg is fixed,
wherein the plate part is provided with a transmission prevention hole configured to prevent the sonic vibration module from coming into contact with the plate part.

5. The abdominal massage device equipped with a sonic vibration module of claim 4, wherein the transmission prevention hole is disposed at a position overlapping the sonic vibration module in a height direction.

6. The abdominal massage device equipped with a sonic vibration module of claim 4,
wherein the plate part is provided with a fixing member that is inserted and fixed into a fastening hole formed in the fixing bar while passing through a through hole formed in the leg, and
a blocking member configured to prevent the transmission of sonic vibrations is provided on an inner circumferential surface of the through hole.

7. The abdominal massage device equipped with a sonic vibration module of claim 4, wherein the acupressure part comprises an acupressure ball arranged to be in contact with a user's abdomen, and a fixing foam configured to fix a position of the acupressure ball.

8. The abdominal massage device equipped with a sonic vibration module of claim 7, wherein a damping member configured to prevent noise caused by impact is provided between the sonic vibration module and the acupressure part.

9. The abdominal massage device equipped with a sonic vibration module of claim 8,
wherein a guide rib extending in a height direction is provided on an inner circumferential surface of the transmission prevention hole,
the damping member is disposed inside the guide rib, and
the damping member and the guide rib are spaced apart from each other in a width direction.

10. The abdominal massage device equipped with a sonic vibration module of claim 4, wherein a heating member for heating the acupressure part is provided between the plate part and the acupressure part.

11. The abdominal massage device equipped with a sonic vibration module of claim 1, wherein a separation space is provided between the sonic vibration module and the upper cover part.

12. The abdominal massage device equipped with a sonic vibration module of claim 11, wherein a vibration-isolating foam member configured to prevent resonance between the upper cover part and the sonic vibration module is provided in the separation space.

13. The abdominal massage device equipped with a sonic vibration module of claim 1, wherein the lower cover part is disposed along a perimeter of the acupressure part so that the acupressure part is exposed toward the user's abdomen.
